(19) United States
(12) Patent Application Publication
(10) Pub. No.: US 2024/0155613 A1
(43) Pub. Date: May 9, 2024

(54) PUCCH CONFIGURATIONS FOR REDUCED BANDWIDTH UEs

(71) Applicant: Telefonaktiebolaget LM Ericsson (publ), Stockholm (SE)

(72) Inventors: Mohammad Mozaffari, Fremont, CA (US); Yi-Pin Eric Wang, Fremont, CA (US); Anders Wallén, Ystad (SE); Yi-Ju Chen, Solna (SE)

(21) Appl. No.: 18/281,798

(22) PCT Filed: Mar. 21, 2022
(86) PCT No.: PCT/SE2022/050265

§ 371 Date: Sep. 13, 2023

Related U.S. Application Data
(60) Provisional application No. 63/164,268, filed on Mar. 22, 2021.

(51) Int. Cl. H04W 72/21; H04L 5/00

(52) U.S. Cl. CPC H04W 72/21; H04L 5/0007; H04L 5/0053

(57) ABSTRACT

Systems and methods for supporting Physical Uplink Control Channel (PUCCH) transmissions of reduced bandwidth User Equipments (UEs) to efficiently coexist with regular UEs in a network. In some embodiments, a method performed by a UE comprises obtaining a PUCCH configuration for reduced bandwidth UEs wherein there is a dependency between the PUCCH configuration for reduced bandwidth UEs and a PUCCH configuration for non-reduced bandwidth UEs. The method further comprises transmitting a PUCCH in accordance with the PUCCH configuration for reduced bandwidth UEs.

### RELATED APPLICATIONS

This application claims the benefit of provisional patent application Ser. No. 63/164,268, filed Mar. 22, 2021, the disclosure of which is hereby incorporated herein by reference in its entirety.

### TECHNICAL FIELD

The present disclosure is related to New Radio (NR) Reduced Capability (RedCap) User Equipments (UEs) and base stations communicating with the RedCap UEs. In particular, the present disclosure is related to an issue of reduced maximum UE bandwidth. The present disclosure provides solutions for supporting Physical Uplink Control Channel (PUCCH) transmissions of RedCap UEs (reduced bandwidth UEs) to efficiently coexist with regular UEs in a network.

### BACKGROUND

The next paradigm shift in processing and manufacturing is the Industry 4.0 in which factories are automated and made much more flexible and dynamic with the help of wireless connectivity. This includes real-time control of robots and machines using time-critical machine-type communication (cMTC) and improved observability, control, and error detection with the help of large numbers of more simple actuators and sensors (massive machine-type communication or mMTC). For cMTC support, Ultra-Reliable Low-Latency Communication (URLLC) was introduced in Third Generation Partnership Project (3GPP) Release 15 for both Long Term Evolution (LTE) and New Radio (NR), and NR URLLC is further enhanced in Release 16 within the enhanced URLLC (eURLLC) and Industrial Internet of Things (IoT) work items.

For mMTC and low power wide area (LPWA) support, 3GPP introduced both narrowband Internet-of-Things (NB-IoT) and long-term evolution for machine-type communication (LTE-MTC, or LTE-M) in Release 13. These technologies have been further enhanced through all releases up until and including the ongoing Release 16 work.

NR was introduced in 3GPP Release 15 and focused mainly on the enhanced mobile broadband (eMBB) and cMTC. However, there are still several other use cases whose requirements are higher than LPWA Network (LPWAN) (i.e., LTE-M/ NB-IoT) but lower than URLLC and eMBB (see, e.g., RP-202933, New WID on support of reduced capability NR devices, 3GPP TSG RAN #90e, December 2020.). In order to efficiently support such use cases which are in-between eMBB, URLLC, and mMTC, the 3GPP has studied reduced capability NR devices (NR-RedCap) in Release 17 (see, e.g., 3GPP Technical Report (TR) 38.875, “Study on support of reduced capability NR devices (Release 17),” December 2020.). The RedCap as a study item has been completed in December 2020 and is going to continue as a work item (see e.g., RP-202933, New WID on support of reduced capability NR devices, 3GPP TSG RAN #90e, Dec. 2020.). The NR-RedCap User Equipments (UEs) are designed to have lower cost, lower complexity, a longer battery life, and enable a smaller form factor than legacy NR UEs. For RedCap UEs, different complexity reduction features including the reduced bandwidth and reduced number of antennas have been considered.

According to Release 15 and 16 NR specifications, a UE is required to support 100 Megahertz (MHz) in frequency range 1 (FR1) and 200 MHz in frequency range 2 (FR2). These bandwidth requirements are considerably higher than what is needed from the data rate requirements of the RedCap use cases. Therefore, reduced bandwidth options including 20 MHz in FR1 and 50 MHz or 100 MHz in FR2 have been studied. According to the new RedCap NR devices work item, it is required to specify support for the following reduced maximum UE bandwidth features [RAN1, RAN4] as follows:
Maximum bandwidth of an FR1 RedCap UE during and after initial access of 20 MHz is supported. The possibility of, and any associated conditions for, optional support of a wider bandwidth up to 40 MHz after initial access for this case will be further discussed at RAN#91e.
Maximum bandwidth of an FR2 RedCap UE during and after initial access is 100 MHz.

Embodiments described herein related to UEs with reduced bandwidth are however not limited to the above examples. Furthermore, the maximum transmitter bandwidth and the maximum receiver bandwidth in the UE may be different. Where the UE bandwidth is referred to below, this may pertain to either the transmitted bandwidth or the receiver bandwidth or both.

For support of UEs with different capabilities (e.g., bandwidth) in a network, it is important to ensure an efficient coexistence of different UEs while considering resource utilization, network spectral/energy efficiency, and scheduling complexity. In this regard, it is beneficial to have shared initial downlink (DL) and uplink (UL) bandwidth parts (BWPs) between different UEs particularly to avoid resource fragmentation and improve resource efficiency. For example, it is desired to support shared initial BWPs (which are used for initial access) between RedCap UEs and legacy UEs.

The first step in initial access is that a UE detects the DL synchronization reference signals, including primary synchronization signal (PSS) and secondary synchronization signal (SSS). Following that, the UE reads the physical broadcast channel (PBCH), which includes master information block (MIB). Among other information, the MIB contains PDCCH-ConfigSIB1, which is the configuration of Control Resource Set (CORESET) #0 (CORESET0). After decoding CORESET0, which is the DL assignment for the remaining system information, the UE can receive System Information Block 1 (SIB1) including the random access channel (RACH) configuration.

Random access is the procedure of UE accessing a cell, receiving a unique identification by the cell, and receiving the basic radio resource configurations. The steps of four-step random access are as follows:
The UE transmits a preamble referred to as Physical Random Access Channel (PRACH).
The network detects the preamble and sends random access response (RAR), indicating reception of the preamble and providing a time-alignment command.
Responsive to reception of the RAR, the UE sends a physical uplink shared channel (PUSCH), a.k.a., Message 3 (Msg3), aiming at resolving collision.
Responsive to receiving Msg3, the network sends the contention resolution message, a.k.a., Message 4 (Msg4).
Responsive to receiving the Msg4, the UE sends the ACK/NACK for Msg4 on the physical uplink control channel (PUCCH).

In NR, a two-step random access procedure (also called Type 2 random access) is also defined. The steps of the two-step random access procedure are as follows:
The UE transmits a Message A (MsgA), which includes a random access preamble together with higher layer data such as RRC connection request possibly with some small payload on PUSCH.
After detecting the MsgA, the network sends a RAR (called Message B or MsgB) including UE identifier assignment, timing advance information, and contention resolution message, etc.

In general, PUCCH is used by the UE for carrying uplink control information (UCI) for various purposes such as Hybrid Automatic Repeat Request (HARQ) feedback, Channel State Information (CSI), and Scheduling Request (SR). NR supports five different PUCCH formats (i.e., Formats 0-4). PUCCH formats 0 and 2, which are known as short formats, occupy 1 or 2 Orthogonal Frequency Division Multiplexing (OFDM) symbols. PUCCH formats 1, 3, and 4 are known as long formats which occupy 4 to 14 OFDM symbols. Moreover, frequency hopping is supported for long PUCCH formats and for short PUCCH formats of duration two symbols.

Before a dedicated Radio Resource Control (RRC) connection (i.e., during random/initial access), the PUCCH configuration is done in PUCCH-ConfigCommon (shown in Table 1) from SIB1. The information element (IE) PUCCH-ConfigCommon is used to configure the cell specific PUCCH parameters.

TABLE 1
PUCCH-ConfigCommon information element [4].

| | |
|---|---|
| PUCCH-ConfigCommon ::= | SEQUENCE { |
| pucch-ResourceCommon | INTEGER (0..15) |
| OPTIONAL, -- Cond InitialBWP-Only | |
| pucch-GroupHopping | ENUMERATED { neither, enable, |
| disable }, | |
| hoppingId | INTEGER (0..1023) |
| OPTIONAL, -- Need R | |
| p0-nominal | INTEGER (−202..24) |
| OPTIONAL, -- Need R | |
| ... | |
| } | |

The parameter pucch-ResourceCommon is an entry into a 16-row table where each row configures a set of cell-specific PUCCH resources/parameters. The UE uses those PUCCH resources until it is provided with a dedicated PUCCH-Config (e.g., during initial access) on the initial UL BWP.

Such PUCCH configuration in PUCCH-ConfigCommon only supports short Format 0 with two symbols and long Format 1 with 4, 10, and 14 symbols. Also, in this configuration, frequency hopping is always applied. Therefore, for PUCCH transmissions for Msg4 (four-step RACH) or MsgB (two-step RACH) HARQ feedback during the random access procedure, the frequency hopping within a slot (intra-slot frequency hopping) is always enabled. In FIG. 1, an example of PUCCH configuration with frequency hopping enabled is shown.

### SUMMARY

Systems and methods for supporting Physical Uplink Control Channel (PUCCH) transmissions of Reduced Capability (RedCap) User Equipments (UEs) (reduced bandwidth UEs) to coexist with regular UEs in a network are disclosed herein. In one embodiment, a method performed by a wireless communication device (WCD), comprises obtaining a PUCCH configuration for reduced bandwidth WCDs. There is a dependency between the PUCCH configuration for reduced bandwidth WCDs and a PUCCH configuration for non-reduced bandwidth WCDs. The method further comprises transmitting a PUCCH in accordance with the PUCCH configuration for reduced bandwidth WCDs. Embodiments of the proposed solutions may provide suitable PUCCH configurations to ensure that PUCCH transmissions fall within the UE bandwidth while avoiding resource fragmentation.

In one embodiment, the PUCCH configuration for reduced bandwidth WCDs is the same as the PUCCH configuration for non-reduced bandwidth WCDs and an intra-slot frequency hopping for the reduced bandwidth WCDs is disabled.

In one embodiment, the PUCCH configuration for reduced bandwidth WCDs is the same as the PUCCH configuration for non-reduced bandwidth WCDs except that, in a time slot, only one of two or more frequency hops defined by the PUCCH configuration for the non-reduced bandwidth WCDs is active for the reduced bandwidth WCDs.

In one embodiment, the one of the two or more frequency hops that is active for reduced bandwidth WCDs is based on one or more parameters comprising at least one of (a) channel condition and (b) a preferred carrier frequency position of the reduced bandwidth WCDs.

In one embodiment, the PUCCH configuration for reduced bandwidth WCDs and/or the PUCCH configuration for non-reduced bandwidth WCDs enable or disable intra-slot frequency hopping based on one or more parameters.

In one embodiment, the one or more parameters comprise whether or not reduced bandwidth WCDs and non-reduced bandwidth WCDs have a same initial uplink bandwidth part.

In one embodiment, the PUCCH configuration for reduced bandwidth WCDs and the PUCCH configuration for non-reduced bandwidth WCDs have non-overlapping or partially overlapping time-domain configurations.

In one embodiment, the PUCCH configuration for reduced bandwidth WCDs and the PUCCH configuration for non-reduced bandwidth WCDs have different numbers of PUCCH symbols per frequency hop.

In one embodiment, the PUCCH configuration for reduced bandwidth WCDs is such that the number of PUCCH symbols and/or locations of PUCCH symbols within a slot for reduced bandwidth UEs is/are based on one or more factors.

In one embodiment, the one or more factors comprise a coverage requirement for reduced bandwidth WCDs and/or a number of PUCCH symbols.

In one embodiment, the PUCCH configuration for reduced bandwidth WCDs is such that there is a fixed time offset between PUCCH resources for reduced bandwidth WCDs and PUCCH resources for non-reduced bandwidth WCDs.

In one embodiment, the PUCCH configuration for non-reduced bandwidth WCDs uses intra-slot frequency hopping.

In one embodiment, the PUCCH configuration for non-reduced bandwidth WCDs uses inter-slot frequency hopping, and the PUCCH configuration for reduced bandwidth WCDs uses one frequency hop every K slots, where K is greater than or equal to 1.

In one embodiment, the PUCCH configuration for non-reduced bandwidth WCDs is such that, in the time slot, the one of the two or more frequency hops that is active for reduced bandwidth WCDs is extended in time and/or frequency.

In one embodiment, the PUCCH configuration for reduced bandwidth WCDs and the PUCCH configuration for non-reduced bandwidth WCDs use different time-domain configurations and have overlapping frequency-domain configurations.

In one embodiment, the PUCCH configuration for reduced bandwidth WCDs and the PUCCH configuration for non-reduced bandwidth WCDs configure different frequency-domain PUCCH resources for reduced bandwidth WCDs and non-reduced bandwidth WCDs.

In one embodiment, the different frequency-domain PUCCH resources are adjacent in the frequency-domain.

In one embodiment, the PUCCH configuration for reduced bandwidth WCDs defines a frequency hopping pattern for PUCCH for reduced bandwidth WCDs in which a second hop within a slot starts with a delay relative to an end of a first hop within the slot.

In one embodiment, the delay is based on a desired radio frequency (RF) tuning time for reduced bandwidth WCDs, subcarrier spacing, the bandwidth of the WCD, the size of an uplink bandwidth part in which the WCD operates, and/or number of PUCCH symbols in each hop.

In one embodiment, the PUCCH configuration for reduced bandwidth WCDs enables intra-slot frequency hopping.

In one embodiment, the PUCCH configuration for reduced bandwidth WCDs is such that a PUCCH length for each hop and a position of PUCCH resources within a slot are jointly determined based on the delay such that two hops are located in one slot.

In one embodiment, the PUCCH configuration for reduced bandwidth WCDs is such that a PUCCH length for each hop and a position of PUCCH resources within a slot are adjusted such that the PUCCH resources for reduced bandwidth WCDs are aligned with PUCCH resources for non-reduced bandwidth WCDs.

In one embodiment, the PUCCH configuration for reduced bandwidth WCDs is such that PUCCH resources in at least one hop for reduced bandwidth WCDs overlap, at least partly, with PUCCH resources for non-reduced bandwidth WCDs such that either the start or end of the PUCCH resources for reduced bandwidth WCDs are not aligned with either the start or end of the PUCCH resources for non-reduced bandwidth WCDs.

In one embodiment, positions of a DMRS within the PUCCH resources for reduced bandwidth WCDs are the PUCCH configuration for reduced bandwidth WCDs is such that PUCCH resources in adjusted such that the DMRS within the PUCCH resources for reduced bandwidth WCDs coincides in time with DMRS within PUCCH resources for non-reduced bandwidth WCDs.

In one embodiment, the PUCCH length for reduced bandwidth WCDs is adaptively adjusted once the base station knows one or more related capabilities of the WCD.

In one embodiment, the PUCCH configuration for reduced bandwidth WCDs is the same as the PUCCH configuration for non-reduced bandwidth WCDs but with the delay between the hops.

In one embodiment, the WCD skips one or more PUCCH symbols to accommodate for RF retuning between adjacent frequency hops.

In one embodiment, the step of obtaining the PUCCH configuration for reduced bandwidth WCDs comprises receiving the PUCCH configuration for reduced bandwidth WCDs from a base station.

In one embodiment, the step of receiving the PUCCH configuration for reduced bandwidth WCDs from the base station comprises receiving the PUCCH configuration for reduced bandwidth WCDs from the base station via a broadcast of system information.

In one embodiment, the PUCCH configuration for reduced bandwidth WCDs is indicated in the system information separately from the PUCCH configuration for non-reduced bandwidth WCDs.

In one embodiment, the step of obtaining the PUCCH configuration for reduced bandwidth WCDs comprises receiving the PUCCH configuration for non-reduced bandwidth WCDs from a base station and deriving the PUCCH configuration for reduced bandwidth WCDs based on a known or signaled dependency between the PUCCH configuration for reduced bandwidth WCDs and the PUCCH configuration for non-reduced bandwidth WCDs.

In one embodiment, the PUCCH configuration for reduced bandwidth WCDs is dependent on PUCCH format.

In one embodiment, the PUCCH configuration for reduced bandwidth WCDs is a PUCCH configuration for reduced bandwidth WCDs that is applicable for initial or random access, and the PUCCH configuration for non-reduced bandwidth WCDs is a PUCCH configuration for non-reduced bandwidth WCDs that is applicable for initial or random access.

In one embodiment, the PUCCH comprises a Hybrid Automatic Repeat Request (HARQ) feedback for a Message 3 of a 4-step random access procedure or a Message B of a 2-step random access procedure.

In one embodiment, a method performed by a base station comprises providing, to one or more reduced bandwidth WCDs, a PUCCH configuration for reduced bandwidth WCDs. There is a dependency between the PUCCH configuration for reduced bandwidth WCDs and a PUCCH configuration for non-reduced bandwidth WCDs. The method further comprises receiving a PUCCH in accordance with the PUCCH configuration for reduced bandwidth WCDs.

In one embodiment, the PUCCH configuration for reduced bandwidth WCDs is the same as the PUCCH configuration for non-reduced bandwidth WCDs and an intra-slot frequency hopping for the reduced bandwidth WCDs is disabled.

In one embodiment, the PUCCH configuration for reduced bandwidth WCDs is the same as the PUCCH configuration for non-reduced bandwidth WCDs except that, in a time slot, only one of two or more frequency hops defined by the PUCCH configuration for non-reduced bandwidth WCDs is active for reduced bandwidth WCDs.

In one embodiment, the one or more parameters comprise at least one of a channel condition and a preferred carrier frequency position of the reduced bandwidth WCDs.

In one embodiment, the PUCCH configuration for reduced bandwidth WCDs or the PUCCH configuration for non-reduced bandwidth WCDs enable or disable intra-slot frequency hopping based on one or more parameters.

In one embodiment, the one or more parameters comprise whether or not reduced bandwidth WCDs and non-reduced bandwidth WCDs have a same initial uplink bandwidth part.

In one embodiment, the PUCCH configuration for reduced bandwidth WCDs and the PUCCH configuration for non-reduced bandwidth WCDs have non-overlapping or partially overlapping time-domain configurations.

In one embodiment, the PUCCH configuration for reduced bandwidth WCDs and the PUCCH configuration for non-reduced bandwidth WCDs have different numbers of PUCCH symbols per frequency hop.

In one embodiment, the PUCCH configuration for reduced bandwidth WCDs is such that the number of PUCCH symbols or locations of PUCCH symbols within a slot for reduced bandwidth UEs is/are based on one or more factors.

In one embodiment, the one or more factors comprise a coverage requirement for reduced bandwidth WCDs or a number of PUCCH symbols.

In one embodiment, the PUCCH configuration for reduced bandwidth WCDs is such that there is a fixed time offset between PUCCH resources for reduced bandwidth WCDs and PUCCH resources for non-reduced bandwidth WCDs.

In one embodiment, the PUCCH configuration for non-reduced bandwidth WCDs uses intra-slot frequency hopping.

In one embodiment, the PUCCH configuration for non-reduced bandwidth WCDs uses inter-slot frequency hopping, and the PUCCH configuration for reduced bandwidth WCDs uses one frequency hop every K slots, where K is greater than or equal to 1.

In one embodiment, the PUCCH configuration for non-reduced bandwidth WCDs is such that, in the time slot, the one of the two or more frequency hops that is active for reduced bandwidth WCDs is extended in time or frequency.

In one embodiment, the PUCCH configuration for reduced bandwidth WCDs and the PUCCH configuration for non-reduced bandwidth WCDs use different time-domain configurations and have overlapping frequency-domain configurations.

In one embodiment, the PUCCH configuration for reduced bandwidth WCDs and the PUCCH configuration for non-reduced bandwidth WCDs configure different frequency-domain PUCCH resources for reduced bandwidth WCDs and non-reduced bandwidth WCDs.

In one embodiment, the different frequency-domain PUCCH resources are adjacent in the frequency-domain.

In one embodiment, the PUCCH configuration for reduced bandwidth WCDs defines a frequency hopping pattern for PUCCH for reduced bandwidth WCDs in which a second hop within a slot starts with a delay relative to an end of a first hop within the slot.

In one embodiment, the delay is based on a desired radio frequency (RF) tuning time for reduced bandwidth WCDs, subcarrier spacing, the bandwidth of the WCD, the size of an uplink bandwidth part in which the WCD operates, or number of PUCCH symbols in each hop.

In one embodiment, the PUCCH configuration for reduced bandwidth WCDs enables intra-slot frequency hopping.

In one embodiment, the PUCCH configuration for reduced bandwidth WCDs is such that a PUCCH length for each hop and a position of PUCCH resources within a slot are jointly determined based on the delay such that two hops are located in one slot.

In one embodiment, the PUCCH configuration for reduced bandwidth WCDs is such that a PUCCH length for each hop and a position of PUCCH resources within a slot are adjusted such that the PUCCH resources for reduced bandwidth WCDs are aligned with PUCCH resources for non-reduced bandwidth WCDs.

In one embodiment, the PUCCH configuration for reduced bandwidth WCDs is such that PUCCH resources in at least one hop for reduced bandwidth WCDs overlap, at least partly, with PUCCH resources for non-reduced bandwidth WCDs such that either the start or end of the PUCCH resources for reduced bandwidth WCDs are not aligned with either the start or end of the PUCCH resources for non-reduced bandwidth WCDs.

In one embodiment, positions of a Demodulation Reference Signal (DMRS) within the PUCCH resources for reduced bandwidth WCDs are the PUCCH configuration for reduced bandwidth WCDs is such that PUCCH resources in adjusted such that the DMRS within the PUCCH resources for reduced bandwidth WCDs coincides in time with DMRS within PUCCH resources for non-reduced bandwidth WCDs.

In one embodiment, the PUCCH length for reduced bandwidth WCDs is adaptively adjusted once the base station knows one or more related capabilities of the WCD.

In one embodiment, the PUCCH configuration for reduced bandwidth WCDs is the same as the PUCCH configuration for non-reduced bandwidth WCDs but with the delay between the hops.

In one embodiment, the WCD skips one or more PUCCH symbols to accommodate for RF retuning between adjacent frequency hops.

Corresponding embodiments of the WCD are also disclosed.

A WCD is adapted to obtain a PUCCH configuration for reduced bandwidth WCDs. There is a dependency between the PUCCH configuration for reduced bandwidth WCDs and a PUCCH configuration for non-reduced bandwidth WCDs. The WCD is further adapted to transmit a PUCCH in accordance with the PUCCH configuration for reduced bandwidth WCDs.

A WCD comprises one or more transmitters; one or more receivers; and processing circuitry associated with the one or more transmitters and the one or more receivers, the processing circuitry configured to cause the wireless communication device to obtain a PUCCH configuration for reduced bandwidth WCDs. There is a dependency between the PUCCH configuration for reduced bandwidth WCDs and a PUCCH configuration for non-reduced bandwidth WCDs. The processing circuitry is further configured to cause the WCD to transmit a PUCCH in accordance with the PUCCH configuration for reduced bandwidth WCDs.

Corresponding embodiments of the base station are also disclosed.

A base station is adapted to provide, to one or more reduced bandwidth WCDs, a PUCCH configuration for reduced bandwidth WCDs. There is a dependency between the PUCCH configuration for reduced bandwidth WCDs and a PUCCH configuration for non-reduced bandwidth WCDs. The base station is further adapted to receive a PUCCH in accordance with the PUCCH configuration for reduced bandwidth WCDs.

A base station comprising processing circuitry configured to cause the base station to provide, to one or more reduced bandwidth WCDs, a PUCCH configuration for reduced bandwidth WCDs and to receive a PUCCH in accordance with the PUCCH configuration for reduced bandwidth WCDs. There is a dependency between the PUCCH configuration for reduced bandwidth WCDs and a PUCCH configuration for non-reduced bandwidth WCDs. The processing circuitry is further configured to cause the base station to receive a PUCCH in accordance with the PUCCH configuration for reduced bandwidth WCDs.

### BRIEF DESCRIPTION OF THE DRAWINGS

The accompanying drawing figures incorporated in and forming a part of this specification illustrate several aspects of the disclosure, and together with the description serve to explain the principles of the disclosure. Optional features are represented by dashed boxes.

FIG. 1 illustrates an example of Physical Uplink Control Channel (PUCCH) configuration with frequency hopping enabled.

FIG. 2 illustrates a possibility of resource fragmentation when configuring different PUCCH resources for Reduced Capability (RedCap) User Equipments (UEs) and non-RedCap UEs (i.e., regular UEs).

FIG. 3 illustrates one example of a cellular communications system 300 in which embodiments of the present disclosure may be implemented.

FIG. 4 illustrates shared PUCCH resources in one slot with disabled intra-slot frequency hopping for RedCap UEs according to some embodiments of the present disclosure.

FIG. 5 illustrates an example of inter-slot frequency hopping for RedCap UEs during random/initial access according to some embodiments of the present disclosure.

FIG. 6 illustrates one example of an extended RedCap PUCCH without frequency hopping according to some embodiments of the present disclosure.

FIG. 7 illustrates that RedCap UEs use different time-domain configurations than non-RedCap UEs while having overlap in frequency domain according to some embodiments of the present disclosure.

FIG. 8 illustrates an example in which frequency resources for RedCap PUCCH are adjacent to frequency resources for non-RedCap PUCCH in one slot according to some embodiments of the present disclosure.

FIG. 9 illustrates that a new frequency hopping pattern is used for RedCap PUCCH in which the second hop starts with a delay according to some embodiments of the present disclosure.

FIG. 10 illustrates one operation of a base station (e.g., a gNB) and a wireless communication device (e.g., a UE) in accordance with some of the embodiments.

FIG. 11 illustrates another operation of the base station (e.g., a gNB) and the wireless communication device (e.g., a UE) in accordance with some of the embodiments.

FIG. 12 is a schematic block diagram of a radio access node (e.g., a base station, a gNB) according to some embodiments of the present disclosure.

FIG. 13 is a schematic block diagram that illustrates a virtualized embodiment of the radio access node according to some embodiments of the present disclosure.

FIG. 14 is a schematic block diagram of the radio access node according to some other embodiments of the present disclosure.

FIG. 15 is a schematic block diagram of the according to some embodiments of the present disclosure.

FIG. 16 is a schematic block diagram of the wireless communication device (e.g., a UE) according to some other embodiments of the present disclosure.

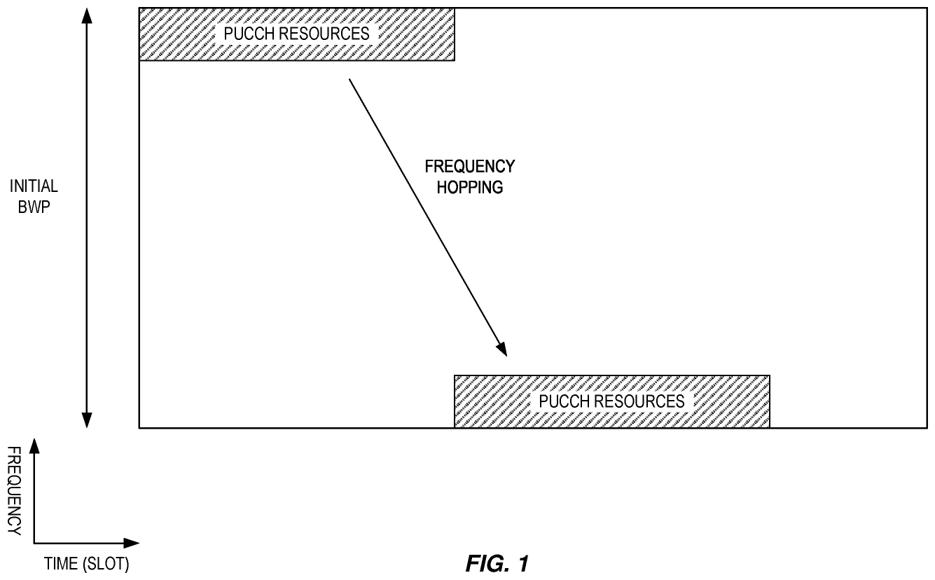

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device (WCD).

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device or WCD: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). In support of UEs with different bandwidths, configuring separate Physical Uplink Control Channel (PUCCH) configurations and/or separate initial Bandwidth Parts (BWPs) for different UEs can result in resource fragmentation, thus degrading the spectral efficiency. Meanwhile, sharing the initial Uplink (UL) BWP between different UEs with different bandwidth capabilities can pose challenges as the initial UL BWP may be configured up to the entire carrier bandwidth. One of the key issues that needs to be addressed is related to PUCCH transmissions for Msg4 (four-step RACH) or MsgB (two-step RACH) Hybrid Automatic Repeat Request (HARQ) feedback during the random access procedure. Specifically, when frequency hopping is enabled for PUCCH in the initial UL BWP, the Physical Resource Blocks (PRBs) used for PUCCH are determined based on the initial UL BWP configuration, which may have a bandwidth larger than the maximum UE bandwidth. In this case, it is important to enable/support that PUCCH (for Msg4/MsgB HARQ feedback) transmissions fall within the UE bandwidth. Therefore, suitable PUCCH configurations are needed to ensure efficient coexistence between UEs with different capabilities and avoid resource fragmentation.

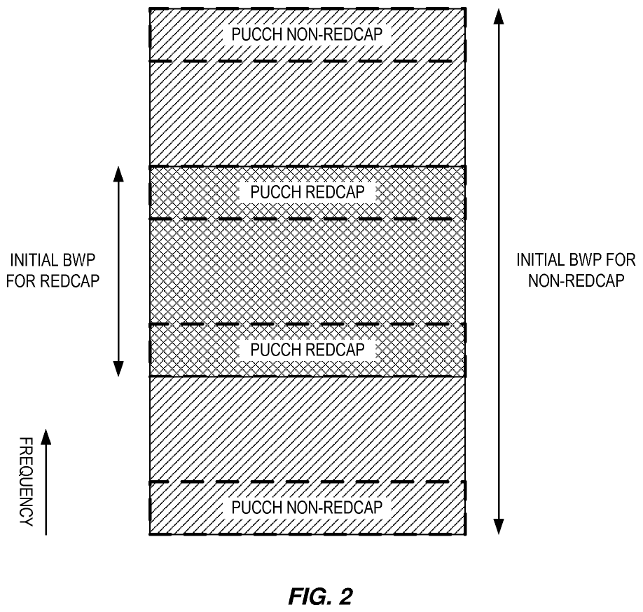

As an illustrative example, FIG. 2 shows a possibility of resource fragmentation when configuring different PUCCH resources for Reduced Capability (RedCap) UEs and non-RedCap UEs (i.e., regular UEs). As shown in FIG. 2, with the different resources allocated to PUCCH for supporting non-RedCap and RedCap UEs, the remaining available resources for PUSCH are fragmented to three non-contiguous frequency-domain resources. This prevents these available PUSCH resources from being used for serving one UE if Discrete Fourier Transform Spread OFDM (DFT-S-OFDM) is used for PUSCH, as DFT-S-OFDM requires contiguous frequency-domain resource allocation. Thus, the available PUSCH resources may be unutilized if the NR base station (gNB) can only schedule one UE at the same time due to, e.g., that there is only one UE to be scheduled for PUSCH in the beam direction in a symbol or slot interval.

It should be noted that, one possible solution for enabling RedCap UEs to use the non-RedCap PUCCH configuration is to perform radio frequency (RF) retuning. In particular, when the size of initial BWP is larger than the RedCap bandwidth, the RedCap UEs can do RF-retuning within a slot between two PUCCH hops. However, due the RF retuning delay, which can be a few symbols, the support of intra-slot frequency hopping by only relying on the RF-retuning is challenging and may not even be feasible depending on the scenario.

Certain aspects of the present disclosure and their embodiments may provide solutions to the aforementioned or other challenges. Systems and methods are disclosed herein that provide suitable PUCCH configurations that allow reduced bandwidth UEs to efficiently coexist with regular UEs (i.e., non-reduced bandwidth UEs) in a network. Specifically, embodiments of the solutions described herein ensure that PUCCH (for Msg4/MsgB HARQ feedback) transmissions fall within the bandwidth of the reduced bandwidth UEs. In some embodiments, the proposed solutions identify the time and frequency locations for PUCCH configurations that avoid resource fragmentation when supporting UEs with different bandwidth capabilities. The new configurations cover different cases including: 1) overlapping time and frequency PUCCH resources, 2) non-overlapping time and frequency PUCCH resources, and 3) non-overlapping time or frequency PUCCH resources. Another aspect of some embodiments of the proposed solutions is that they consider dependency between PUCCH configurations for regular UEs and reduced bandwidth UEs.

Note that the term “PUCCH configuration” is used herein both as capturing the parameters for PUCCH transmission that are explicitly signaled from the network to the UE through, e.g., System information, as described above, but also in more general terms to describe parameters for PUCCH transmission that are determined by the UE and/or a network node in some other way.

Embodiments of the solutions described herein may include one or more of the following aspects:

Proposing new PUCCH configurations that enable efficient coexistence of UEs with different bandwidth capabilities in a network.

Identifying the suitable time and frequency locations for PUCCH configurations that avoid resource fragmentation.

Ensuring that PUCCH (for Msg4/MsgB HARQ feedback) transmissions fall within the bandwidth of the reduced bandwidth UEs.

New solutions enable using the same initial BWP for reduced bandwidth UEs and regular UEs.

Considering dependency between PUCCH configurations for regular UEs and reduced bandwidth UEs to ensure an efficient coexistence performance.

There are, proposed herein, various embodiments which address one or more of the issues disclosed herein.

Certain embodiments may provide one or more of the following technical advantage(s). Embodiments of the proposed solutions may enable the support of random access procedure for reduced bandwidth UEs in coexistence with regular UEs in a network. In particular, suitable PUCCH configurations are identified to ensure that PUCCH (for Msg4/MsgB HARQ feedback) transmissions fall within the UE bandwidth while avoiding resource fragmentation. The solutions can be beneficial for, e.g.: 1) efficient support of UEs with different capabilities in a network and 2) resource utilization, avoiding resource fragmentation, scheduling flexibility, network capacity.

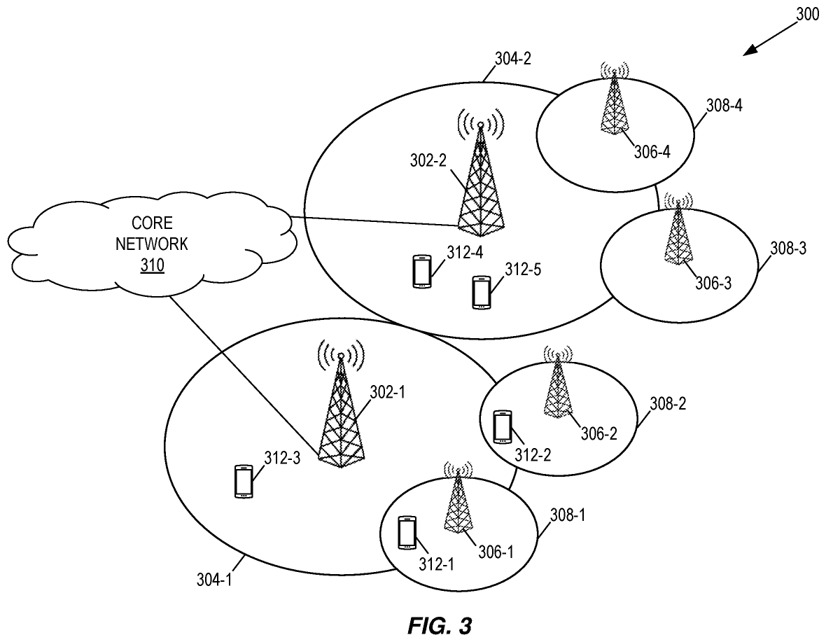

FIG. 3 illustrates one example of a cellular communications system 300 in which embodiments of the present disclosure may be implemented. In the embodiments described herein, the cellular communications system 300 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC); however, the embodiments disclosed herein are not limited thereto. In this example, the RAN includes base stations 302-1 and 302-2, which in the NG-RAN include NR base stations (gNBs) and optionally next generation eNBs (ng-eNBs) (e.g., LTE RAN nodes connected to the 5GC) and in the E-UTRAN include eNBs, controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or Remote Radio Heads (RRHs), or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5GS is referred to as the 5GC and in the EPS is referred to as the EPC. The base stations 302 (and optionally the low power nodes 306) are connected to the core network 310.

The base stations 302 and the low power nodes 306 provide service to wireless communication devices (WCDs) 312-1 through 312-5 in the corresponding cells 304 and 308. The WCDs 312-1 through 312-5 are generally referred to herein collectively as WCDs 312 and individually as WCD 312. In the following description, the WCDs 312 are oftentimes UEs and, as such, are sometimes referred to herein as UEs 312, but the present disclosure is not limited thereto.

In the embodiments described herein, some of the UEs 312 are reduced bandwidth UEs (e.g., RedCap UEs) while some others of the UEs 312 are non-reduced bandwidth UEs (e.g., non-RedCap UEs such as NR UEs that support eMBB services or any other UEs that support a bandwidth that is greater than that supported by the reduced bandwidth UEs). For purposes of notation, reduced bandwidth UEs or RedCap UEs are referenced by reference number “312-R”, and non-reduced bandwidth UEs or non-RedCap UEs are referenced by reference number “312-F”. Note that the embodiments of the solutions described herein can also be applied to cases where there are more than two UE bandwidths. For example, there may be multiple reduced-BW UEs with different bandwidths (e.g., RedCap 1, RedCap 2, etc.) coexisting with normal UEs. In some embodiments, the solutions may also depend on the UE bandwidth/BWP size.

In the following, various PUCCH configurations are described which are particularly useful for reduced bandwidth UEs 312-R that coexist with larger bandwidth UEs 312-F during random/initial access procedure (e.g., for PUCCH for Msg4 or MsgB ACK). These configurations are applicable to both scenarios with shared initial BWPs and separate initial BWPs. Here, as a non-limiting example of UEs with different bandwidths, RedCap UEs 312-R and non-RedCap UEs 312-F (regular NR UEs) are considered. In the proposed solutions, there is a dependency between PUCCH configurations for RedCap and non-RedCap UEs. Specifically: 1) non-RedCap configurations can be selected such that they are more suitable for RedCap, and/or 2) RedCap configurations are adjusted based on non-RedCap configurations.

### Solution Type 1

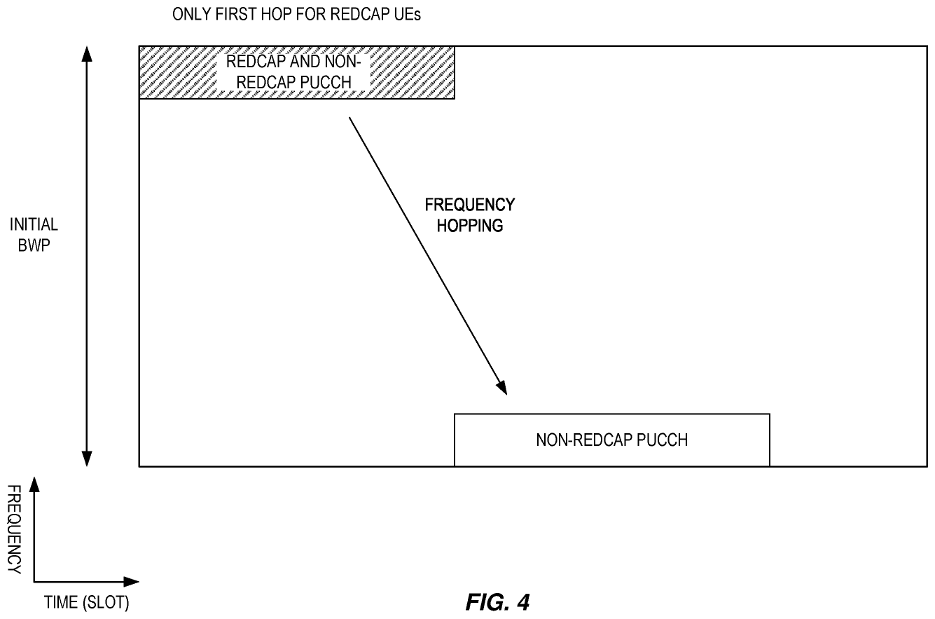

In one embodiment, the RedCap UEs 312-R use the same PUCCH configuration in the initial BWP as non-RedCap UEs 312-F but without intra-slot frequency hopping. That is, in each slot, only one hop (either the first or second hop) is active for the RedCap UEs 312-R, as shown in FIG. 4. The hop can be selected based on various factors including channel condition and the preferred position of UE carrier frequency. More precisely, it can be based on the relative position of RedCap and non-RedCap UL BWPs such that resources are not fragmentated. It is desired to use the PUCCH hop located at the carrier edge and disable the one which is in the middle of the carrier. Hence, the PUCCH resources must be mapped to the one edge and the edge can be configured by the gNB based on the scenario (e.g., the location of the RedCap UL BWP with respect to non-RedCap UL BWP/carrier). For example, if the center of RedCap UL BWP is above the center of non-RedCap BWP, then the lower hop is disabled and upper hop is enabled.

FIG. 4 illustrates shared PUCCH resources in one slot with disabled intra-slot frequency hopping for RedCap UEs 312-R (i.e., in each slot, only one hop is active for RedCap). In the example of FIG. 4, only the first hop is active for RedCap UEs 312-R; however, in another example, only the second hop is active for RedCap UEs 312-R.

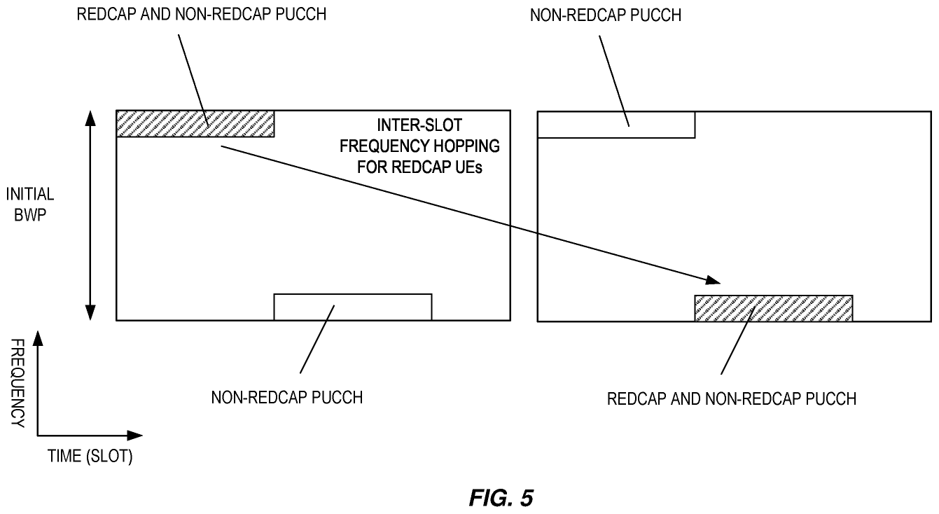

In the current NR specifications, for PUCCH during random/initial access (e.g., for Msg 4 or MsgB ACK), only intra-slot frequency hopping is supported. In another embodiment, instead of intra-slot frequency hopping, inter-slot frequency hopping is used for PUCCH during random/initial access (e.g., for Msg 4 or MsgB ACK) for RedCap UEs 312-R, where the RedCap UE 312-R switches between hops every K slots. Such switching can be done by proper RF retuning. For example, FIG. 5 shows an example of inter-slot frequency hopping with K=1 for RedCap UEs 312-R during random/initial access.

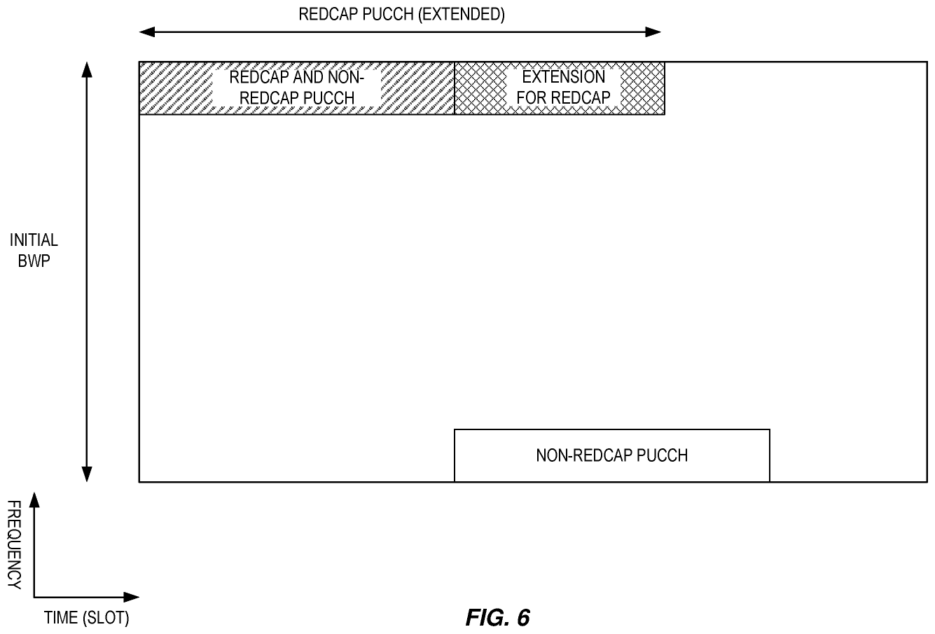

Since the embodiments above result in only half of the PUCCH resources being utilized for transmission by a RedCap UE 312-R compared to a non-RedCap UE 312-F, one can expect a degradation of PUCCH reception performance in the base station 302 (e.g., gNB). In one embodiment, the length of the PUCCH transmission is therefore increased for a RedCap UE 312-R in order to compensate for the performance loss. This may be done by repetition of the PUCCH transmission, for example directly following the first one, or at a later occasion. For example, FIG. 6 illustrates one example of an extended RedCap PUCCH without frequency hopping (e.g., using only the first hop, in the illustrated example). In this case, the RedCap UE 312-R uses only one hop (either the first or second hop) of the non-RedCap PUCCH resources and extends this one hop of the PUCCH resource in time domain for coverage compensation.

### Solution Type 2

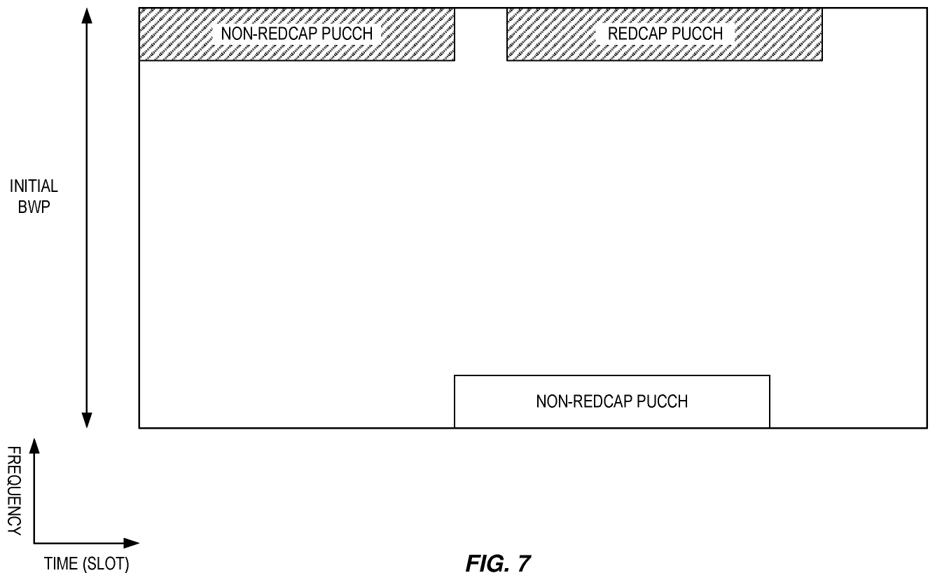

In another solution, as shown in FIG. 7, RedCap UEs 312-R use different time-domain configurations than non-RedCap UEs 312-F while having overlap in frequency domain. In this case, PUCCH symbols for RedCap UEs 312-R and non-RedCap UEs 312-F can be non-overlapped or partially overlapped. Also, the number of PUCCH symbols per hop for RedCap UEs 312-R and non-RedCap UEs 312-F can be different. Note that, in this configuration, depending on the scenario, the intra-slot frequency hopping can be enabled or disabled. If the initial BWP is shared between RedCap UEs 312-R and non-RedCap UEs 312-F, the intra-slot frequency hopping can be enabled. However, if RedCap UEs 312-R use a separate initial BWP with a different size, then the intra-frequency hopping is disabled to avoid resource fragmentation.

For RedCap UEs 312-R, the number of PUCCH symbols and their locations within a slot can be determined based on several factors including RedCap coverage requirements and the number of PUCCH symbols used for non-RedCap UEs. For example, a fixed time offset can be considered between RedCap and non-RedCap PUCCH resources. This solution can be considered as separate RedCap PUCCH configuration with some dependency on the non-RedCap PUCCH configuration.

### Solution Type 3

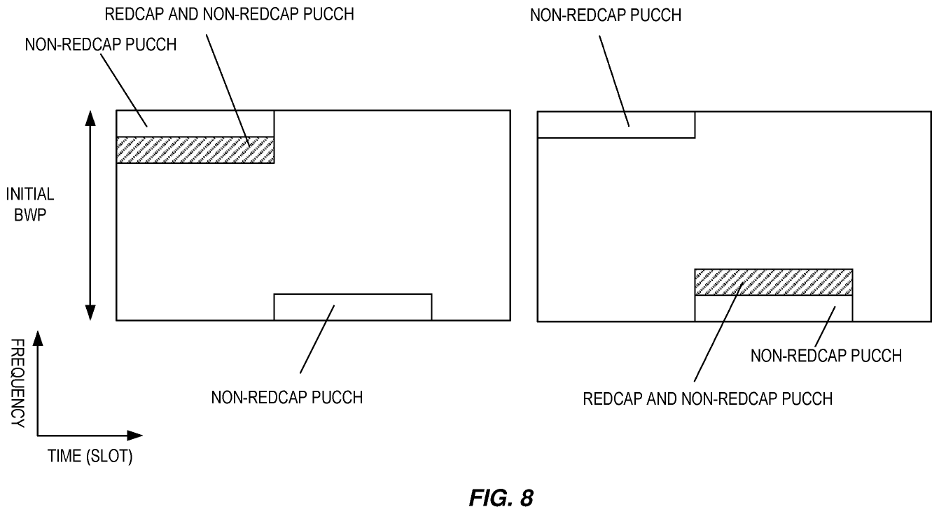

In another solution, separate frequency resources are used for RedCap PUCCH, where the frequency resources used for RedCap PUCCH are adjacent to those used for non-RedCap PUCCH. RedCap PUCCH resources can be adjacent to the first hop or second hop of non-RedCap PUCCH configurations. In this case, the time domain configuration of PUCCH can be the same or different for RedCap and non-RedCap UEs. FIG. 8 illustrates an example in which frequency resources for RedCap PUCCH are adjacent to frequency resources for non-RedCap PUCCH in one slot.

### Solution Type 4

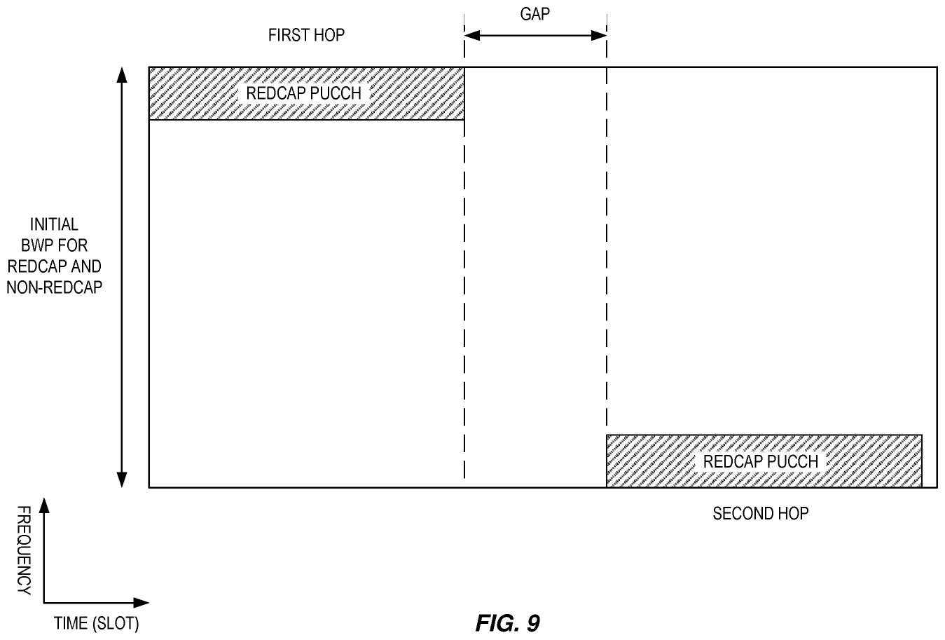

In another solution, a new frequency hopping pattern is used for RedCap PUCCH in which the second hop starts with a delay. One example of this frequency hopping with a time gap is shown in FIG. 9. This delay, or time gap, can accommodate for any RF retuning time that RedCap UE 312-R may require to operate on a BWP that is wider that its bandwidth. In this configuration, the intra-slot frequency hopping can be enabled for RedCap UEs 312-R. The time gap (i.e., delay) between two hops can depend on RF retuning time, subcarrier spacing (SCS), the bandwidth of the UE 312-R, the size of the uplink BWP, and/or number of PUCCH symbols.

In one embodiment, the PUCCH length for each hop and the position of PUCCH resources within a slot are jointly determined based on the RF retuning delay (i.e., the time gap) such that the two hops are located in one slot. Specifically, let L₁ and L₂ be, respectively, the PUCCH lengths (number of symbols) for the first hop and the second hop, and 0≤s≤13 be the index of the starting symbol of PUCCH in the slot (i.e., first symbol of the first hop). Also, let G be the time gap (number of symbols) between two hops which depends on the required RF-retuning time.

In one embodiment, the values of L₁, L₂ and s are specified based on the following condition to ensure both hops are within one slot (with 14 OFDM symbols):

+L₁+L₂+G≤14

In one example, considering L₁=L₂=L, and s=0, we have:

$$L = ⌊ \frac{14 - G}{2} ⌋$$

where └.┘ is the floor function.

In another embodiment, the length and position of RedCap PUCCH resources in each hop are adjusted such that they are aligned (e.g., aligned start symbols) with non-RedCap PUCCH resources.

In another embodiment, the length and position of RedCap PUCCH resources in each hop are adjusted such that they do not overlap with non-RedCap PUCCH resources in either of hops or both.

In another embodiment, the length and position of RedCap PUCCH resources in at least one of the hops overlap partly with non-RedCap PUCCH resources, such that either the start or the end or both of the RedCap and the non-RedCap PUCCH resources are not aligned. In a related embodiment, the relative position of a demodulation reference signal (DMRS) within the RedCap PUCCH resource is adjusted such that the transmission of the DMRS in the RedCap PUCCH resource coincides in time with the transmission of the DMRS in the non-RedCap resource.

In another embodiment, the original/predefined lengths of PUCCH are adaptively adjusted once the UE capability is known to the network. For example, let q₁ and q₂ be the predefined number of PUCCH symbols for the first hop and second hop. Then, the predefined PUCCH lengths may be reduced by (q₁−L₂) and (q₂−L₂) for the first and second hops, respectively. The values of PUCCH length reduction and/or the gap value (G) can be indicated to the base station 302 (e.g., gNB) via Msg3 transmissions.

In another embodiment, the RedCap UE 312-R uses the PUCCH configuration of non-RedCap UEs 312-F with a time gap between the two hops within the slot. In this case, the first hop can be the same for the RedCap UEs 312-R and the non-RedCap UEs 312-F, but the second hop is the delayed version of that of used for the non-RedCap UEs 312-F, when feasible, depending on the non-RedCap PUCCH configuration (i.e., number of PUCCH symbols and their locations within a slot).

In addition, the following embodiments can be envisioned:
The RedCap UE 312-R may skip a portion of existing PUCCH symbols to accommodate for RF-retuning delay. For example, if the required RF retuning time is G symbols, the RedCap UE 312-R may not use (i.e., skip) G symbols of PUCCH in a given configuration. These skipped symbols can belong to the first hop, second hop, or both. The skipped symbols can be optimally selected (i.e., skipping rules) to minimize the performance loss. In a general case, let a₁ and a₂ be the number of skipped symbols from the first hop and the second hop, where (a₁+a₂)=G. In this case, a₁ and a₂ can be optimized e.g., based on the channel condition or any other criteria to minimize the impact on the PUCCH coverage.

Note that various combinations of aforementioned solution types (Solution Types 1-4) can also be implemented. Also note that the solution types and/or parameters used in each solution may depend on the coverage requirements and UE capabilities.

Signaling Aspects The NR specifications may support one or more of the configurations described above. The configuration supported in a cell is signaled in one of the system information blocks. Alternatively, the configuration may be adapted dynamically and signaled via the downlink control information (DCI) that schedules Msg4/[MsgB].

For example, a new RedCap-specific PUCCH configuration can be defined in PUCCH-ConfigCommon information element by adding a new pucch-ResourceCommon for RedCap UEs (e.g., pucch-ResourceCommon_RedCap, as shown in the example below). In this example, an X-row table can be defined in SIB where each row configures a set of RedCap-specific common PUCCH resources/parameters.

TABLE 2
Example of RedCap-specific common PUCCH resources.

| | |
|---|---|
| PUCCH-ConfigCommon ::= | SEQUENCE { |
| pucch-ResourceCommon | INTEGER (0..15) |
| OPTIONAL, -- Cond InitialBWP-Only | |
| pucch-ResourceCommon_RedCap | INTEGER (0..X) |
| OPTIONAL, -- Cond InitialBWP-Only | |
| pucch-GroupHopping | ENUMERATED { neither, enable, |
| disable }, | |
| hoppingId | INTEGER (0..1023) |
| OPTIONAL, -- Need R | |
| p0-nominal | INTEGER (−202..24) |
| OPTIONAL, -- Need R | |
| ... | |
| } | |

The above example of how the new signaling can be introduced is included for illustration purposes. There are several options for how this extension can be introduced in a standard.

### PUCCH Format Dependency

The different embodiments described above can be applied depending on the PUCCH format used in the PUCCH resource. As a non-limiting example, fast frequency hopping for RedCap UEs 312-R may be disabled for the short PUCCH formats 0 and 2, occupying 1 or 2 OFDM symbols, whereas the legacy frequency hopping behavior may be used for longer PUCCH formats. Generally, any of the behaviors described in the different solutions above can be applied based on the PUCCH format. This includes the possibility of puncturing transmission of one or more symbols at the beginning or end of a hop, where this behavior depends on the PUCCH format. Additionally or alternatively, the frequency hopping behavior can depend on the number of symbols configured for the PUCCH format.

### Additional Discussion

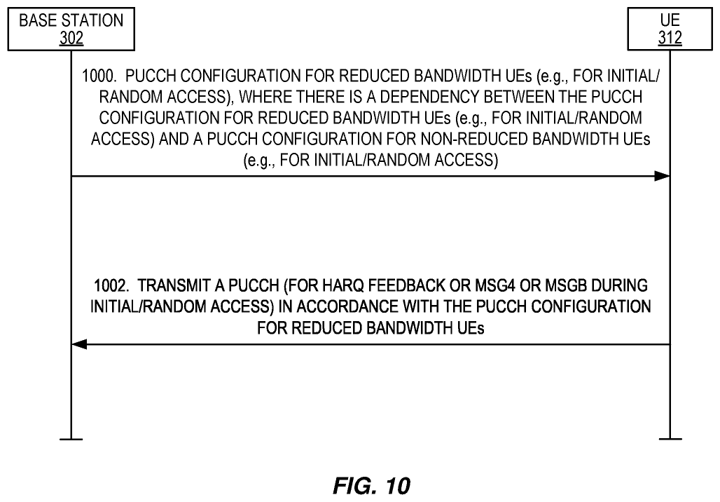

FIG. 10 illustrates the operation of a base station 302 (e.g., a gNB) and a WCD 312 (e.g., a UE 312) in accordance with at least some of the embodiments described above for solution types 1-4. In this example, the WCD 312 is a reduced bandwidth WCD 312-R such as a RedCap UE. As illustrated, the base station 302 provides, to the WCD 312-R, a PUCCH configuration for reduced bandwidth WCDs (e.g., a PUCCH configuration for reduced bandwidth WCDs that is applicable for random or initial access) (step 1000). There is a dependency between the PUCCH configuration for reduced bandwidth WCDs (e.g., that is applicable for random or initial access) and a PUCCH configuration for non-reduced bandwidth WCDs 312-F (e.g., that is applicable for random or initial access). This dependency can be in accordance with any of the embodiments described above for Solution Types 1-4. As discussed above, the PUCCH configuration for reduced bandwidth WCDs may be broadcast in system information (e.g., in the common PUCCH configuration information element) as a common PUCCH configuration specifically for reduced bandwidth WCDs, which is separate from a common PUCCH configuration for non-reduced bandwidth WCDs. However, this is only an example. Other signaling mechanisms may be used, such as dedicated Radio Resource Configuration (RRC) signaling. The WCD 312-R then transmits a PUCCH (e.g., a HARQ ACK/NACK for a Msg3 in the case of 4-step random access or for a MsgB in the case of a 2-step random access) in accordance with the PUCCH configuration for reduced bandwidth (step 1002).

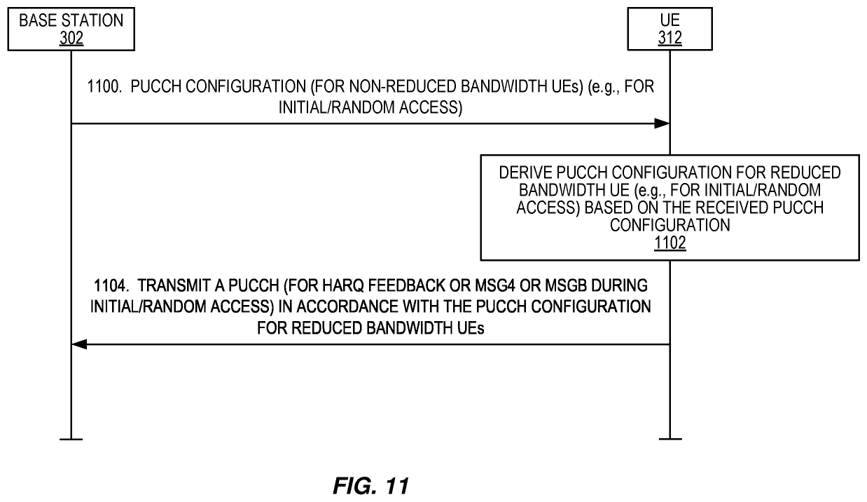

FIG. 11 illustrates the operation of a base station 302 (e.g., a gNB) and a WCD 312 (e.g., a UE 312) in accordance with at least some of the embodiments described above for solution types 1-4. In this example, the WCD 312 is a reduced bandwidth WCD 312-R such as a RedCap UE. As illustrated, the base station 302 provides, to the WCD 312-R, a PUCCH configuration for non-reduced bandwidth WCDs (e.g., that is applicable for random or initial access) (step 1100). The reduced bandwidth WCD 312-R derives a PUCCH configuration for reduced bandwidth WCDs (e.g., that is applicable for random or initial access) based on the received PUCCH configuration for non-reduced bandwidth WCDs (step 1102). As described above, there is a dependency between the PUCCH configuration for reduced bandwidth WCDs (e.g., that is applicable for random or initial access) and a PUCCH configuration for non-reduced bandwidth WCDs 312-F (e.g., that is applicable for random or initial access). This dependency can be in accordance with any of the embodiments described above for Solution Types 1-4. The reduced bandwidth WCD 312-R therefore derives the PUCCH configuration for reduced bandwidth WCDs based on the PUCCH configuration for non-reduced bandwidth WCDs in accordance with a known or signaled dependency between these two PUCCH configurations. The WCD 312-R then transmits a PUCCH (e.g., a HARQ ACK/NACK for a Msg3 in the case of 4-step random access or for a MsgB in the case of a 2-step random access) in accordance with the (derived) PUCCH configuration for reduced bandwidth WCDs (step 1104).

Note that the configuration of PUCCH resources for the RedCap UE 312-R can be either explicit (e.g., explicitly signaled from a network node, such as a base station 302, e.g., in system information as described above with respect to FIG. 10) or derived implicitly (e.g., derived implicitly based on the PUCCH configuration for non-RedCap UEs 312-F, e.g., as described above with respect to FIG. 11). In yet another embodiment, the configuration of PUCCH resources for the RedCap UE 312-R may be done via a combination of explicit and implicit mechanisms (e.g., as a combination of FIGS. 10 and 11). For example, some aspects or parameters of the PUCCH configuration for the RedCap UE 312-R may be signaled explicitly (e.g., as done in FIG. 10), and other aspects or parameters of the PUCCH configuration for the RedCap UE 312-R may be determined implicitly from the PUCCH configuration of a non-RedCap UE and/or from a standards document (e.g., would for example correspond to the “known” dependency).

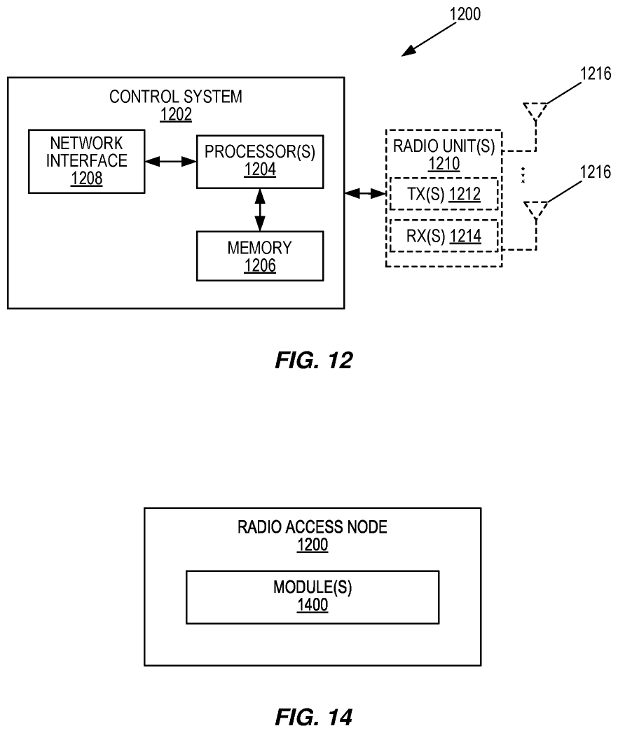

FIG. 12 is a schematic block diagram of a radio access node 1200 according to some embodiments of the present disclosure. Optional features are represented by dashed boxes. The radio access node 1200 may be, for example, a base station 302 or 306 or a network node that implements all or part of the functionality of the base station 302 or gNB described herein. As illustrated, the radio access node 1200 includes a control system 1202 that includes one or more processors 1204 (e.g., Central Processing Units (CPUs), Application Specific Integrated Circuits (ASICs), Field Programmable Gate Arrays (FPGAs), and/or the like), memory 1206, and a network interface 1208. The one or more processors 1204 are also referred to herein as processing circuitry. In addition, the radio access node 1200 may include one or more radio units 1210 that each includes one or more transmitters 1212 and one or more receivers 1214 coupled to one or more antennas 1216. The radio units 1210 may be referred to or be part of radio interface circuitry. In some embodiments, the radio unit(s) 1210 is external to the control system 1202 and connected to the control system 1202 via, e.g., a wired connection (e.g., an optical cable). However, in some other embodiments, the radio unit(s) 1210 and potentially the antenna(s) 1216 are integrated together with the control system 1202. The one or more processors 1204 operate to provide one or more functions of a radio access node 1200 as described herein (e.g., one or more functions of a gNB or base station described herein, e.g., with respect to Solution Types 1-4 and FIGS. 10 and 11). In some embodiments, the function(s) are implemented in software that is stored, e.g., in the memory 1206 and executed by the one or more processors 1204.

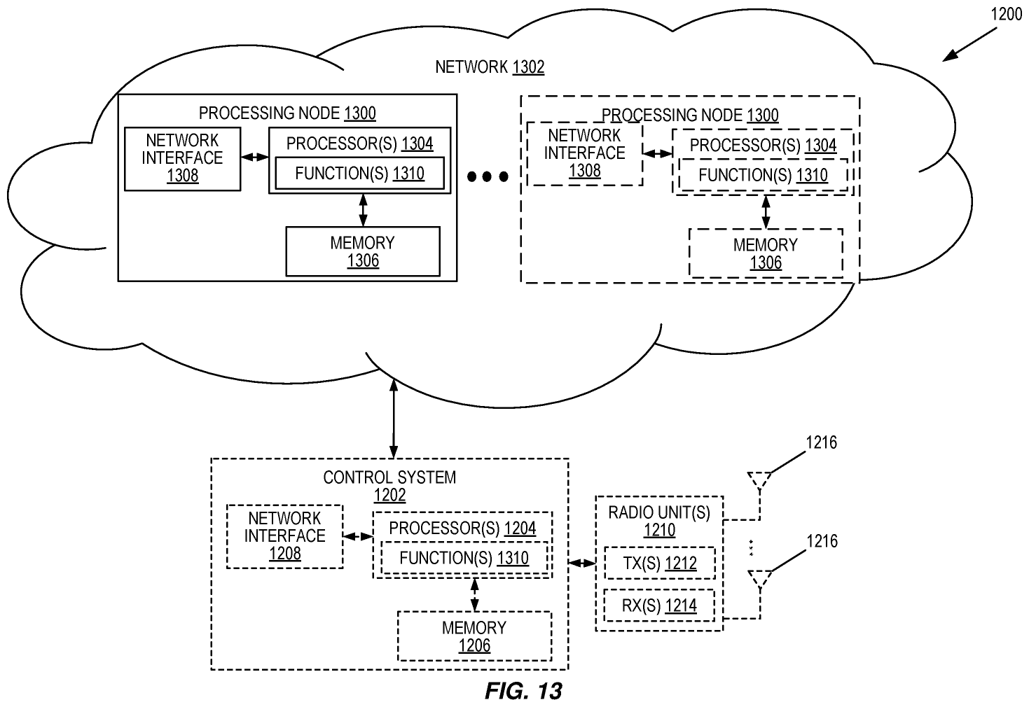

FIG. 13 is a schematic block diagram that illustrates a virtualized embodiment of the radio access node 1200 according to some embodiments of the present disclosure. Again, optional features are represented by dashed boxes. As used herein, a “virtualized” radio access node is an implementation of the radio access node 1200 in which at least a portion of the functionality of the radio access node 1200 is implemented as a virtual component(s) (e.g., via a virtual machine(s) executing on a physical processing node(s) in a network(s)). As illustrated, in this example, the radio access node 1200 may include the control system 1202 and/or the one or more radio units 1210, as described above. The control system 1202 may be connected to the radio unit(s) 1210 via, for example, an optical cable or the like. The radio access node 1200 includes one or more processing nodes 1300 coupled to or included as part of a network(s) 1302. If present, the control system 1202 or the radio unit(s) are connected to the processing node(s) 1300 via the network 1302. Each processing node 1300 includes one or more processors 1304 (e.g., CPUs, ASICs, FPGAs, and/or the like), memory 1306, and a network interface 1308.

In this example, functions 1310 of the radio access node 1200 described herein (e.g., one or more functions of a gNB or base station described herein, e.g., with respect to Solution Types 1-4 and FIGS. 10 and 11) are implemented at the one or more processing nodes 1300 or distributed across the one or more processing nodes 1300 and the control system 1202 and/or the radio unit(s) 1210 in any desired manner. In some particular embodiments, some or all of the functions 1310 of the radio access node 1200 described herein are implemented as virtual components executed by one or more virtual machines implemented in a virtual environment(s) hosted by the processing node(s) 1300. As will be appreciated by one of ordinary skill in the art, additional signaling or communication between the processing node(s) 1300 and the control system 1202 is used in order to carry out at least some of the desired functions 1310. Notably, in some embodiments, the control system 1202 may not be included, in which case the radio unit(s) 1210 communicate directly with the processing node(s) 1300 via an appropriate network interface(s).

In some embodiments, a computer program including instructions which, when executed by at least one processor, causes the at least one processor to carry out the functionality of the radio access node 1200 or a node (e.g., a processing node 1300) implementing one or more of the functions 1310 of the radio access node 1200 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the radio access node 1200 according to some other embodiments of the present disclosure. The radio access node 1200 includes one or more modules 1400, each of which is implemented in software. The module(s) 1400 provide the functionality of the radio access node 1200 described herein (e.g., one or more functions of a gNB or base station described herein, e.g., with respect to Solution Types 1-4 and FIGS. 10 and 11). This discussion is equally applicable to the processing node 1300 of FIG. 13 where the modules 1400 may be implemented at one of the processing nodes 1300 or distributed across multiple processing nodes 1300 and/or distributed across the processing node(s) 1300 and the control system 1202.

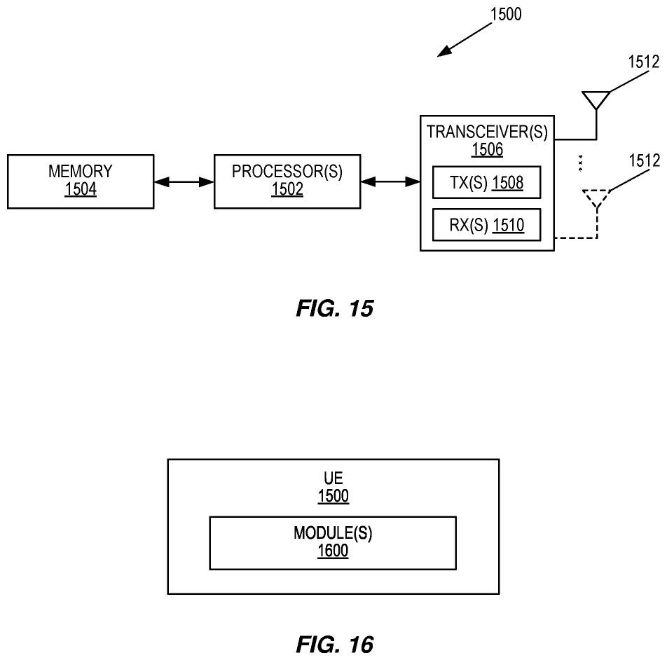

FIG. 15 is a schematic block diagram of a WCD 312 according to some embodiments of the present disclosure. The WCD 312 may be a reduced bandwidth WCD Q112-R (e.g., a RedCap UE) or a non-reduced bandwidth WCD 312-F (e.g., a non-RedCap UE). As illustrated, the WCD 312 includes one or more processors 1502 (e.g., CPUs, ASICs, FPGAs, and/or the like), memory 1504, and one or more transceivers 1506 each including one or more transmitters 1508 and one or more receivers 1510 coupled to one or more antennas 1512. The transceiver(s) 1506 includes radio-front end circuitry connected to the antenna(s) 1512 that is configured to condition signals communicated between the antenna(s) 1512 and the processor(s) 1502, as will be appreciated by on of ordinary skill in the art. The processors 1502 are also referred to herein as processing circuitry. The transceivers 1506 are also referred to herein as radio circuitry. In some embodiments, the functionality of the WCD 312 described above may be fully or partially implemented in software that is, e.g., stored in the memory 1504 and executed by the processor(s) 1502. Note that the WCD 312 may include additional components not illustrated in FIG. 15 such as, e.g., one or more user interface components (e.g., an input/output interface including a display, buttons, a touch screen, a microphone, a speaker(s), and/or the like and/or any other components for allowing input of information into the WCD 312 and/or allowing output of information from the WCD 312), a power supply (e.g., a battery and associated power circuitry), etc.

In some embodiments, a computer program including instructions which, when executed by at least one processor, causes the at least one processor to carry out the functionality of the WCD 312 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the WCD 312 according to some other embodiments of the present disclosure. The WCD 312 includes one or more modules 1600, each of which is implemented in software. The module(s) 1600 provide the functionality of the WCD 312 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
ASIC Application Specific Integrated Circuit
BWP Bandwidth Part
cMTC Time-Critical Machine-Type Communication
CORESET Control Resource Set
CPU Central Processing Unit
CSI Channel State Information
DCI Downlink Control Information
DFT-S-OFDM Discrete Fourier Transform Spread OFDM
DL Downlink
DMRS
DSP
eMBB
eNB
EPC
EPS
eURLLC
Demodulation Reference Signal
Digital Signal Processor
Enhanced Mobile Broadband
Enhanced or Evolved Node B
Evolved Packet Core
Evolved Packet System
eURLLC enhanced Ultra-Reliable Low-Latency Communication
E-UTRA Evolved Universal Terrestrial Radio Access
FPGA Field Programmable Gate Array
FR Frequency Range
gNB New Radio Base Station
gNB-CU New Radio Base Station Central Unit
gNB-DU New Radio Base Station Distributed Unit
HARQ Hybrid Automatic Repeat Request
HSS Home Subscriber Server
IE Information Element
IoT Internet of Things
IP Internet Protocol
LPWA Low Power Wide Area
LPWAN Low Power Wide Area Network
LTE Long Term Evolution
LTE-MTC Long Term Evolution for Machine Type Communication
MAC Medium Access Control
MIB Master Information Block
MME Mobility Management Entity
MsgA Message A
MsgB Message B
MTC Machine Type Communication
NB-IoT narrowband Internet-of-Things
NEF Network Exposure Function
NR New Radio
NR-RedCap Reduced Capability NR devices
OFDM Orthogonal Frequency Division Multiplexing
PBCH Physical Broadcast Channel
PC Personal Computer
PDSCH Physical Downlink Shared Channel
PRACH Physical Random Access Channel
PRB Physical Resource Block
PSS Primary Synchronization Signal
PUCCH Physical Uplink Control Channel
PUSCH Physical Uplink Shared Channel
QoS Quality of Service
RACH Random Access Channel
RAM Random Access Memory
RAN Radio Access Network
RAR Random Access Response
RedCap Reduced Capability
RF Radio Frequency
ROM Read Only Memory
RRC Radio Resource Control
RRH Remote Radio Head
SCS Subcarrier Spacing
SIB1 System Information Block 1
SR Scheduling Request
SSS Secondary Synchronization Signal
TCI Transmission Configuration Indicator
TRP Transmission/Reception Point
UCI Uplink Control Information
UE User Equipment
UL Uplink
URLLC Ultra-Reliable Low-Latency Communication
WCD Wireless Communication Device

Those skilled in the art will recognize improvements and modifications to the embodiments of the present disclosure. All such improvements and modifications are considered within the scope of the concepts disclosed herein.

1. A method performed by a reduced bandwidth Wireless Communication Device, WCD, the method comprising:
obtaining a Physical Uplink Control Channel, PUCCH, configuration for reduced bandwidth WCDs, wherein there is a dependency between the PUCCH configuration for reduced bandwidth WCDs and a PUCCH configuration for non-reduced bandwidth WCDs; and
transmitting a PUCCH in accordance with the PUCCH configuration for reduced bandwidth WCDs.

2. (canceled)

3. The method of claim 1, wherein the PUCCH configuration for reduced bandwidth WCDs is the same as the PUCCH configuration for non-reduced bandwidth WCDs except that, in a time slot, only one of two or more frequency hops defined by the PUCCH configuration for the non-reduced bandwidth WCDs is active for the reduced bandwidth WCDs.

4. (canceled)

5. The method of claim 1, wherein the PUCCH configuration for reduced bandwidth WCDs and/or the PUCCH configuration for non-reduced bandwidth WCDs enable or disable intra-slot frequency hopping based on one or more parameters.

6. The method of claim 5, wherein the one or more parameters comprise whether or not the reduced bandwidth WCDs and the non-reduced bandwidth WCDs have a same initial uplink bandwidth part.

7-13. (canceled)

14. The method of claim 1, wherein the PUCCH configuration for non-reduced bandwidth WCDs is such that, in the time slot, the one of the two or more frequency hops that is active for reduced bandwidth WCDs is extended in time and/or frequency.

15. The method of claim 14, wherein the PUCCH configuration for reduced bandwidth WCDs and the PUCCH configuration for non-reduced bandwidth WCDs use different time-domain configurations and have overlapping frequency-domain configurations.

16. The method of claim 1, wherein the PUCCH configuration for reduced bandwidth WCDs and the PUCCH configuration for non-reduced bandwidth WCDs configure different frequency-domain PUCCH resources for reduced bandwidth WCDs and non-reduced bandwidth WCDs.

17. The method of claim 16, wherein the different frequency-domain PUCCH resources are adjacent in the frequency-domain.

18-27. (canceled)

28. The method of claim 1, wherein obtaining the PUCCH configuration for reduced bandwidth WCDs comprises receiving the PUCCH configuration for reduced bandwidth WCDs from a base station.

29. The method of claim 28, wherein receiving the PUCCH configuration for reduced bandwidth WCDs from the base station comprises receiving the PUCCH configuration for reduced bandwidth WCDs from the base station via a broadcast of system information.

30. The method of claim 29, wherein the PUCCH configuration for reduced bandwidth WCDs is indicated in the system information separately from the PUCCH configuration for non-reduced bandwidth WCDs.

31. The method of claim 1, wherein obtaining the PUCCH configuration for reduced bandwidth WCDs comprises:
receiving the PUCCH configuration for non-reduced bandwidth WCDs from a base station; and
deriving the PUCCH configuration for reduced bandwidth WCDs based on a known or signaled dependency between the PUCCH configuration for reduced bandwidth WCDs and the PUCCH configuration for non-reduced bandwidth WCDs.

32. The method of claim 1, wherein the PUCCH configuration for reduced bandwidth WCDs is dependent on PUCCH format.

33. (canceled)

34. (canceled)

35. A method performed by a base station, the method comprising:
providing, to one or more reduced bandwidth Wireless Communication Devices, WCDs, a Physical Uplink Control Channel, PUCCH, configuration for reduced bandwidth WCDs, wherein there is a dependency between the PUCCH configuration for reduced bandwidth WCDs and a PUCCH configuration for non-reduced bandwidth WCDs; and
receiving a PUCCH in accordance with the PUCCH configuration for reduced bandwidth WCDs.

36. (canceled)

37. The method of claim 35, wherein the PUCCH configuration for reduced bandwidth WCDs is the same as the PUCCH configuration for non-reduced bandwidth WCDs except that, in a time slot, only one of two or more frequency hops defined by the PUCCH configuration for non-reduced bandwidth WCDs is active for reduced bandwidth WCDs.

38. (canceled)

39. The method of claim 35, wherein the PUCCH configuration for reduced bandwidth WCDs and/or the PUCCH configuration for non-reduced bandwidth WCDs enable or disable intra-slot frequency hopping based on one or more parameters.

40. The method of claim 39, wherein the one or more parameters comprise whether or not reduced bandwidth WCDs and non-reduced bandwidth WCDs have a same initial uplink bandwidth part.

41-47. (canceled)

48. The method of claim 35, wherein the PUCCH configuration for non-reduced bandwidth WCDs is such that, in the time slot, the one of the two or more frequency hops that is active for reduced bandwidth WCDs is extended in time and/or frequency.

49. The method of claim 48, wherein the PUCCH configuration for reduced bandwidth WCDs and the PUCCH configuration for non-reduced bandwidth WCDs use different time-domain configurations and have overlapping frequency-domain configurations.

50. The method of claim 35, wherein the PUCCH configuration for reduced bandwidth WCDs and the PUCCH configuration for non-reduced bandwidth WCDs configure different frequency-domain PUCCH resources for reduced bandwidth WCDs and non-reduced bandwidth WCDs.

51. The method of claim 50, wherein the different frequency-domain PUCCH resources are adjacent in the frequency-domain.

52-61. (canceled)

62. A reduced bandwidth Wireless Communication Device, WCD, adapted to:
obtain a Physical Uplink Control Channel, PUCCH, configuration for reduced bandwidth WCDs, wherein there is a dependency between the PUCCH configuration for reduced bandwidth WCDs and a PUCCH configuration for non-reduced bandwidth WCDs; and
transmit a PUCCH in accordance with the PUCCH configuration for reduced bandwidth WCDs.

63-65. (canceled)

66. A base station adapted to:
provide, to one or more reduced bandwidth Wireless Communication Devices, WCDs, a Physical Uplink Control Channel, PUCCH, configuration for reduced bandwidth WCDs, wherein there is a dependency between the PUCCH configuration for reduced bandwidth WCDs and a PUCCH configuration for non-reduced bandwidth WCDs; and
receive a PUCCH in accordance with the PUCCH configuration for reduced bandwidth WCDs.

67-69. (canceled)
